(19) United States
(12) Patent Application Publication
(10) Pub. No.: US 2008/0137198 A1
(43) Pub. Date: Jun. 12, 2008

(54) Optical plate having three layers and backlight module with same

(75) Inventors: Tung-Ming Hsu, Tu-cheng (TW); Shao-Han Chang, Tu-cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI Precision Industry CO., LTD., Tu-Cheng City (TW)

(21) Appl. No.: 11/716,141

(22) Filed: Mar. 9, 2007

(30) Foreign Application Priority Data
Dec. 8, 2006 (CN) 200610201246.0

(51) Int. Cl. G02B 5/02

(52) U.S. Cl. 359/599

(57) ABSTRACT

An exemplary optical plate includes a first transparent layer, a second transparent layer and a light diffusion layer between the first and second transparent layers. The first transparent layer, the light diffusion layer, and the second transparent layer are integrally formed, with the first transparent layer in immediate contact with the light diffusion layer, and the second transparent layer in immediate contact with the light diffusion layer. The first transparent layer defines a plurality of conical frustum protrusions protruding out from an outer surface distalmost from the second transparent layer. The second transparent layer defines a plurality of conical frustum depressions at an outer surface thereof distalmost from the first transparent layer.

### CROSS-REFERENCE TO RELATED APPLICATIONS

This application is related to nine copending U.S. patent applications, which are: application Ser. No. 11/620,951 filed on Jan. 8, 2007, and entitled “OPTICAL PLATE HAVING THREE LAYERS”; application Ser. No. 11/620,958, filed on Jan. 8, 2007, and entitled “OPTICAL PLATE HAVING THREE LAYERS AND MICRO PROTRUSIONS”; application Ser. No. 11/623,302, filed on Jan. 5, 2007, and entitled “OPTICAL PLATE HAVING THREE LAYERS”; application Ser. No. 11/623,303, filed on Jan. 15, 2007, and entitled “OPTICAL PLATE HAVING THREE LAYERS AND BACKLIGHT MODULE WITH SAME”; application Ser. No. 11/627,579, filed on Jan. 26, 2007, and entitled “OPTICAL PLATE HAVING THREE LAYERS”; application Ser. No. [to be advised], Attorney Docket No. US12497, and entitled “OPTICAL PLATE HAVING THREE LAYERS AND BACKLIGHT MODULE WITH SAME”; application Ser. No. [to be advised], Attorney Docket No. US12498, and entitled “OPTICAL PLATE HAVING THREE LAYERS AND BACKLIGHT MODULE WITH SAME”; application Ser. No. [to be advised], Attorney Docket No. US12515, and entitled “OPTICAL PLATE HAVING THREE LAYERS AND BACKLIGHT MODULE WITH SAME”; and application Ser. No. [to be advised], Attorney Docket No. US12893, and entitled “OPTICAL PLATE HAVING THREE LAYERS AND BACKLIGHT MODULE WITH SAME”. In all these copending applications, the inventor is Tung-Ming Hsu et al. All of the copending applications have the same assignee as the present application. The disclosures of the above identified applications are incorporated herein by reference.

### BACKGROUND OF THE INVENTION

1. Field of the Invention

The present invention relates to an optical plate for use in, for example, a backlight module, the backlight module being employed in a liquid crystal display (LCD).

2. Discussion of the Related Art

The lightness and slimness of LCD panels make them suitable for a wide variety of uses in electronic devices such as personal digital assistants (PDAs), mobile phones, portable personal computers, and other electronic appliances. Liquid crystal is a substance that cannot by itself emit light. Rather, the liquid crystal relies on receiving light from a light source in order to display images and data. In the case of a typical LCD panel, a backlight module powered by electricity supplies the needed light.

FIG. 7 is a partly exploded, side cross-sectional view of a typical backlight module 10 employing a typical optical diffusion plate. The backlight module 10 includes a housing 11, a plurality of lamps 12 disposed above a base of the housing 11, and a light diffusion plate 13 and a prism sheet 14 stacked on top of the housing 11 in that order. The lamps 12 emit light rays, and inside walls of the housing 11 are configured for reflecting certain of the light rays upwards. The light diffusion plate 13 includes a plurality of dispersion particles therein. The dispersion particles are configured for scattering received light rays and thereby enhancing the uniformity of light rays that exit the light diffusion plate 13. The prism sheet 14 includes a plurality of V-shaped structures at a top thereof. The V-shaped structures are configured for collimating received light rays to a certain extent.

In use, the light rays from the lamps 12 enter the prism sheet 14 after being scattered in the diffusion plate 13. The light rays are refracted and concentrated by the V-shaped structures of the prism sheet 14 so as to increase brightness of light illumination. Finally, the light rays propagate into an LCD panel (not shown) disposed above the prism sheet 14. Even though the diffusion plate 13 and the prism sheet 14 are in contact with each other, a plurality of air pockets still exist at the boundary therebetween. When the backlight module 10 is in use, light passes through the air pockets, and some of the light undergoes total reflection at one or another of the corresponding boundaries. As a result, the light energy utilization ratio of the backlight module 10 is reduced.

Therefore, a new optical plate is desired in order to overcome the above-described shortcomings. A backlight module utilizing such optical plate is also desired.

### SUMMARY

In one aspect, an optical plate includes a first transparent layer, a second transparent layer and a light diffusion layer between the first and second transparent layers. The light diffusion layer includes a transparent matrix resin and a plurality of diffusion particles dispersed in the transparent matrix resin. The first transparent layer, the light diffusion layer, and the second transparent layer are integrally formed, with the first transparent layer in immediate contact with the light diffusion layer, and the second transparent layer in immediate contact with the light diffusion layer. The first transparent layer defines a plurality of conical frustum protrusions at an outer surface that is distalmost from the second transparent layer. The second transparent layer defines a plurality of conical frustum depressions at an outer surface thereof that is distalmost from the first transparent layer.

Other novel features and advantages will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and backlight module. Moreover, in the drawings, like reference numerals designate corresponding parts throughout the several views, and all the views are schematic.

FIG. 1 is an isometric view of an optical plate in accordance with a first embodiment of the present invention.

FIG. 2 is a side cross-sectional view of the optical plate of FIG. 1, taken along line II-II thereof.

FIG. 3 is a bottom plan view of the optical plate of FIG. 1.

FIG. 4 is an exploded, side cross-sectional view of a direct type backlight module in accordance with a second embodiment of the present invention, the backlight module including the optical plate shown in FIG. 2.

FIG. 5 is a top plan view of an optical plate in accordance with a third embodiment of the present invention.

FIG. 6 is a side cross-sectional view of an optical plate in accordance with a fourth embodiment of the present invention.

FIG. 7 is a partly exploded, side cross-sectional view of a conventional backlight module having a prism sheet and a light diffusion plate.

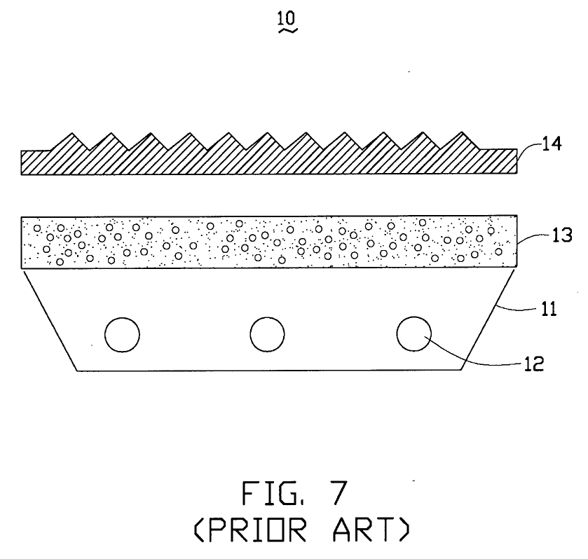

### DETAILED DESCRIPTION OF THE EMBODIMENTS

Reference will now be made to the drawings to describe preferred embodiments of the present optical plate and backlight module, in detail.

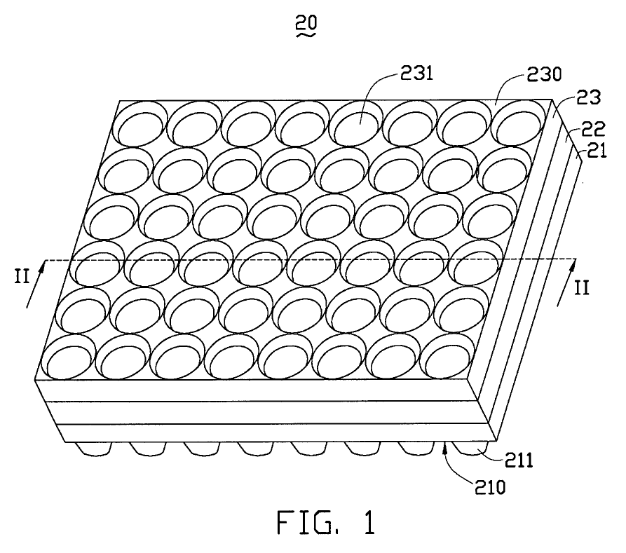

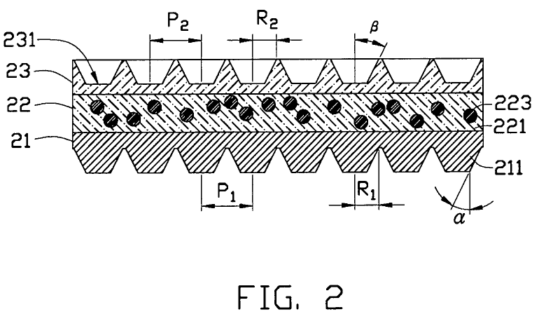

Referring to FIGS. 1 and 2, an optical plate 20 according to a first embodiment of the present invention is shown. The optical plate 20 includes a first transparent layer 21, a light diffusion layer 22, and a second transparent layer 23. The first transparent layer 21, the light diffusion layer 22 and the second transparent layer 23 are integrally formed, with the light diffusion layer 22 being between the first and second transparent layers 21, 23. The first transparent layer 21 and the light diffusion layer 22 are in immediate contact with each other at a first common interface therebetween. Similarly, the second transparent layer 23 and the light diffusion layer 22 are in immediate contact with each other at a second common interface therebetween. This kind of unified body with no gaps in the common interfaces can be made by a multi-shot injection molding method. The first transparent layer 21 includes a plurality of conical frustum protrusions 211 at an outer surface 210 thereof that is distalmost from the light diffusion layer 22. The second transparent layer 23 includes a plurality of conical frustum depressions 231 at an outer surface 230 thereof that is distalmost from the light diffusion layer 22.

A thickness of each of the first transparent layer 21, the light diffusion layer 22, and the second transparent layer 23 can be equal to or greater than 0.35 millimeters. In a preferred embodiment, a combined thickness of the first transparent layer 21, the light diffusion layer 22 and the second transparent layer 23 is in the range from about 1.05 millimeters to about 6 millimeters. Each of the first transparent layer 21 and the second transparent layer 23 is preferably made of transparent matrix resin selected from the group consisting of polyacrylic acid (PAA), polycarbonate (PC), polystyrene (PS), polymethyl methacrylate (PMMA), methylmethacrylate and styrene copolymer (MS), and any combination thereof. It should be noted that the materials of the first and second transparent layers 21, 23 can be the same or can be different.

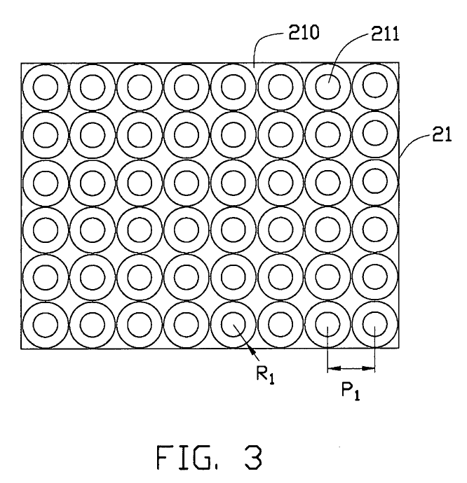

Referring also to FIGS. 2 and 3, each conical frustum protrusion 211 has a flat bottom end parallel with the outer surface 210. The conical frustum protrusion 211 tapers from a top extremity thereof at the outer surface 210 to the bottom end thereof, with the top extremity being larger than the bottom end. The conical frustum protrusions 211 are arranged regularly at the outer surface 210 in a regular m×n matrix, and are separate from one another. A pitch P₁ between centers of two adjacent conical frustum protrusions 211 is preferably in the range from about 0.025 millimeters to about 1.5 millimeters. A maximum radius R₁ of each conical frustum protrusion 231 is preferably in the following range: P₁/4≦R₁≦P₁/2. That is, the radius R₁ is preferably in the range from about 6.25 microns to about 0.75 millimeters. An angle a defined by a side surface of each conical frustum protrusion 211 relative to a vertical central axis (not shown) of the conical frustum protrusion 211 is preferably in a range from about 30 degrees to about 75 degrees.

Referring to FIGS. 1 and 2, the conical frustum depressions 231 are configured for collimating light rays emitting from the optical plate 20, and thereby improving a brightness of light illumination. The conical frustum depressions 231 are arranged at the outer surface 230 of the second transparent layer 23 in a regular m x n matrix. Each conical frustum depression 231 defines a vertical central axis (not labeled). A horizontal width of each conical frustum depression 231 decreases from a top end of the conical frustum depression 231 to a bottom end of the conical frustum depression 231. Thus a cross-section taken along the axis of symmetry of the conical frustum depression 231 defines an isosceles trapezium. A pitch P₂ between two adjacent conical frustum depressions 231 is preferably in the range from about 0.025 millimeters to about 1.5 millimeters. A maximum radius R₂ of a top end of each conical frustum depression 231 is preferably in the range P₂/4≦R₂≦P₂/2. That is, the radius R₂ is preferably in the range from about 6.25 microns to about 0.75 millimeters. An angle 0 of an inner side surface of the conical frustum depression 231 with respect to the central axis of the depression 231 is preferably in the range from about 30 degrees to about 75 degrees. In the illustrated embodiment, the conical frustum depressions 231 at the outer surface 230 are arranged in one-to-one correspondence with the conical frustum protrusions 211 at the outer surfaces 210.

The light diffusion layer 22 includes a transparent matrix resin 221, and a plurality of diffusion particles 223 dispersed in the transparent matrix resin 221. The transparent matrix resin 221 is selected from the group consisting of polyacrylic acid (PAA), polycarbonate (PC), polystyrene (PS), polymethyl methacrylate (PMMA), methylmethacrylate and styrene copolymer (MS), and any combination thereof. The diffusion particles 223 can be made of material selected from the group consisting of titanium dioxide, silicon dioxide, acrylic resin, and any combination thereof. The diffusion particles 223 are configured for scattering light rays and enhancing the uniformity of light exiting the light diffusion layer 22. The light diffusion layer 22 preferably has a light transmission ratio in the range from 30% to 98%. The light transmission ratio of the light diffusion layer 22 is determined by a composition of the transparent matrix resin 221 and the diffusion particles 223.

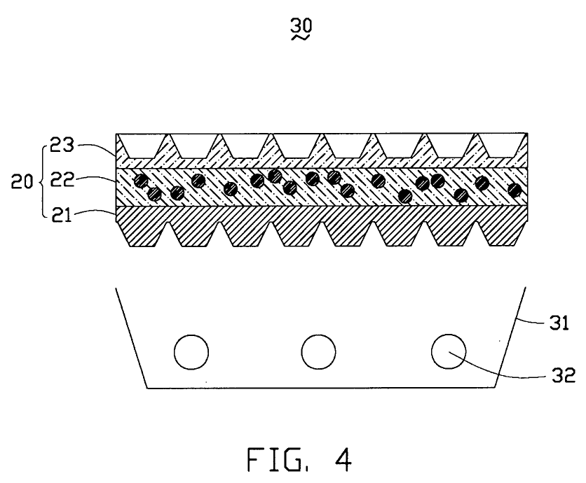

Referring to FIG. 4, a direct type backlight module 30 according to a second embodiment of the present invention is shown. The backlight module 30 includes a housing 31, a plurality of lamp tubes 32, and the optical plate 20. The lamp tubes 32 are regularly arranged above a base of the housing 31. The optical plate 20 is positioned on top of the housing 31, with the first transparent layer 21 facing the lamp tubes 32. In an alternative embodiment, the second transparent layer 23 of the optical plate 20 can be arranged to face the lamp tubes 32. That is, light rays from the lamp tubes 32 can enter the optical plate 20 via a selected one of the first transparent layer 21 and the second transparent layer 23.

In the backlight module 30, when light rays enter the optical plate 20 via the first transparent layer 21, the light rays are diffused by the conical frustum protrusions 211 of the first transparent layer 21. Then the light rays are further substantially diffused in the light diffusion layer 22. Finally, many or most of the light rays are condensed by the conical frustum depressions 231 of the second transparent layer 23 before they exit the optical plate 20. Therefore, a brightness of the backlight module 30 is increased. In addition, the light rays are diffused at two levels, so that a uniformity of light rays output from the optical plate 20 is enhanced. Furthermore, the first transparent layer 21, the light diffusion layer 22, and the second transparent layer 23 are integrally formed together (see above), with no air or gas pockets trapped in the respective common interfaces therebetween. Thus there is little or no back reflection at the common interfaces, and the efficiency of utilization of light rays is increased. Moreover, the optical plate 20 utilized in the backlight module 30 in effect replaces the conventional combination of a diffusion plate and a prism sheet. Thereby, a process of assembly of the backlight module 30 is simplified, and the efficiency of assembly is improved. Still further, in general, a volume occupied by the optical plate 20 is less than that occupied by the conventional combination of a diffusion plate and a prism sheet. Thereby, a volume of the backlight module 30 is reduced.

In the alternative embodiment, when light rays enter the optical plate 20 via the second transparent layer 23, the uniformity of light rays output from the optical plate 20 is also enhanced, and the utilization efficiency of light rays is also increased. Nevertheless, the light rays emitted from the optical plate 20 via the first transparent layer 21 are different from the light rays emitted from the optical plate 20 via the second transparent layer 23. For example, when the light rays enter the optical plate 20 via the first transparent layer 21, a viewing angle provided by the backlight module 30 is somewhat larger than that of the backlight module 30 when the light rays enter the optical plate 20 via the second transparent layer 23.

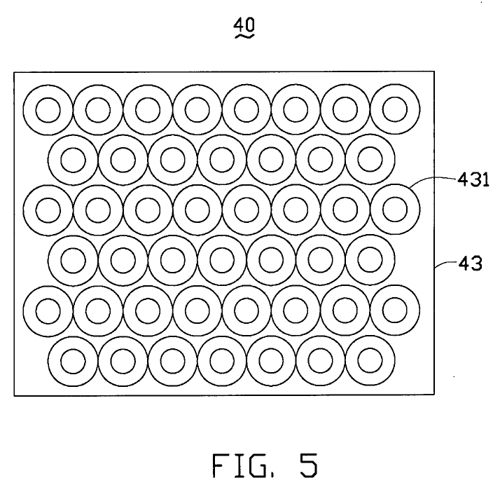

Referring to FIG. 5, an optical plate 40 according to a third embodiment of the present invention is shown. The optical plate 40 is similar in principle to the optical plate 20 of the first embodiment. However, the optical plate 40 includes a second transparent layer 43, and a plurality of conical frustum depressions 431 at an outer surface of the second transparent layer 43. The conical frustum depressions 431 are arranged at the outer surface in a series of rows. The conical frustum depressions 431 in any one same row are connected with each other. The conical frustum depressions 431 in each row are separate from and staggered relative to the conical frustum depressions 431 in each of the two adjacent rows. Thus a matrix comprised of offset rows of the conical frustum depressions 431 is formed. This configuration means that all the conical frustum depressions 431 in the matrix are arranged relatively compactly together.

It should be understood that the conical frustum depressions 231, 431 of the optical plates 20, 40 are not limited to being arranged as described above. In alternative embodiments, the conical frustum depressions 231, 431 can be arranged otherwise. For example, the conical frustum depressions 231, 431 can be arranged randomly at the outer surface. In other alternative embodiments, an arrangement of the conical frustum protrusions 211, 411 can be configured to be the same as, similar to, or different from the arrangement of the conical frustum depressions 231, 431.

In the above-described embodiments, the first common interface between the light diffusion layer and the first transparent layer is flat, and the second common interface between the light diffusion layer and the second transparent layer is also flat. Alternatively, either or both of the common interfaces can be nonplanar. For example, either or both of the common interfaces can be curved or wavy.

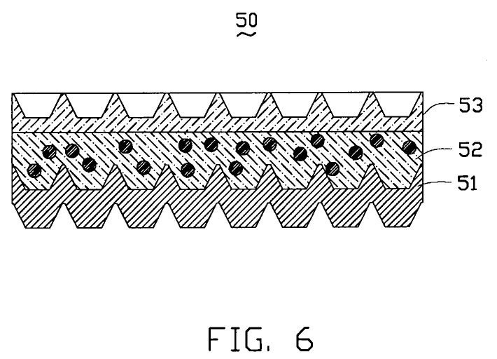

Referring to FIG. 6, an optical plate 50 according to a fourth embodiment is shown. The optical plate 50 is similar in principle to the optical plate 20 of the first embodiment. However, the optical plate 50 includes a first transparent layer 51, a light diffusion layer 52, and a second transparent layer 53. A first common interface (not labeled) between the first transparent layer 51 and the light diffusion layer 52 is jagged. Therefore an area of mechanical engagement between the first transparent layer 51 and the light diffusion layer 52 is increased, and a strength of the mechanical engagement between the first transparent layer 51 and the light diffusion layer 52 is correspondingly increased. In further or alternative embodiments, a second common interface (not labeled) between the second transparent layer 53 and the light diffusion layer 52 can be jagged.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An optical plate, comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin, wherein the first transparent layer, the light diffusion layer, and the second transparent layer are integrally formed, with the first transparent layer in immediate contact with the light diffusion layer, and the second transparent layer in immediate contact with the light diffusion layer, and the first transparent layer comprises a plurality of conical frustum protrusions at an outer surface thereof that is distalmost from the second transparent layer, and the second transparent layer comprises a plurality of conical frustum depressions at an outer surface thereof that is distalmost from the first transparent layer.

2. The optical plate as claimed in claim 1, wherein a thickness of each of the light diffusion layer, the first transparent layer and the second transparent layer is greater than or equal to 0.35 millimeters.

3. The optical plate as claimed in claim 2, wherein a combined thickness of the light diffusion layer, the first transparent layer and the second transparent layer is in the range from about 1.05 millimeters to about 6 millimeters.

4. The optical plate as claimed in claim 1, wherein each of the first transparent layer and the second transparent layer is made of material selected from the group consisting of polyacrylic acid, polycarbonate, polystyrene, polymethyl methacrylate, methylmethacrylate and styrene copolymer, and any combination thereof.

5. The optical plate as claimed in claim 1, wherein a pitch between two adjacent conical frustum depressions is in a range from about 0.025 millimeters to about 1.5 millimeters.

6. The optical plate as claimed in claim 1, wherein a maximum radius of each conical frustum depression is in the range from about 6.25 microns to about 0.75 millimeters.

7. The optical plate as claimed in claim 1, wherein an angle of an inner side surface of each conical frustum depression with respect to a central axis of the conical frustum depression is in the range from about 30 degrees to about 75 degrees.

8. The optical plate as claimed in claim 1, wherein a pitch between two adjacent conical frustum protrusions is in a range from about 0.025 millimeters to about 1.5 millimeters.

9. The optical plate as claimed in claim 1, wherein a maximum radius of each conical frustum protrusion is in the range from about 6.25 microns to about 0.75 millimeters.

10. The optical plate as claimed in claim 1, wherein an angle of an inner side surface of each conical frustum protrusion with respect to a central axis of the conical frustum protrusion is in the range from about 30 degrees to about 75 degrees.

11. The optical plate as claimed in claim 1, wherein at least one of the following arrangements is provided: the conical frustum depressions are arranged in a series of rows at the outer surface of the second transparent layer, and the conical frustum protrusions are arranged in a series of rows at the outer surface of the first transparent layer.

12. The optical plate as claimed in claim 11, wherein at least one of the following arrangements is provided: the conical frustum depressions in any one same row are connected with each other, with the conical frustum depressions in each row being separate from and staggered relative to the conical frustum depressions in each of the two adjacent rows, and the conical frustum protrusions in any one same row are connected with each other, with the conical frustum protrusions in each row being separate from and staggered relative to the conical frustum protrusions in each of the two adjacent rows.

13. The optical plate as claimed in claim 12, wherein the conical frustum depressions are arranged in one-to-one correspondence with the conical frustum protrusions.

14. The optical plate as claimed in claim 1, wherein at least one of the following interfaces is flat: an interface between the light diffusion layer and the first transparent layer, and an interface between the light diffusion layer and the second transparent layer.

15. The optical plate as claimed in claim 1, wherein at least one of the following interfaces is jagged: an interface between the light diffusion layer and the first transparent layer, and an interface between the light diffusion layer and the second transparent layer.

16. The optical plate as claimed in claim 1, wherein the transparent matrix resin is selected from the group consisting of polyacrylic acid, polycarbonate, polystyrene, polymethyl methacrylate, methylmethacrylate and styrene copolymer, and any combination thereof.

17. The optical plate as claimed in claim 1, wherein a material of the diffusion particles is selected from the group consisting of titanium dioxide, silicon dioxide, acrylic resin, and any combination thereof.

18. A direct type backlight module, comprising:
a housing;
a plurality of light sources disposed on or above a base of the housing; and
an optical plate disposed above the light sources at a top of the housing, the optical plate comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin, wherein the first transparent layer, the light diffusion layer, and the second transparent layer are integrally formed, with the first transparent layer in immediate contact with the light diffusion layer, and the second transparent layer in immediate contact with the light diffusion layer, and the first transparent layer comprises a plurality of conical frustum protrusions at an outer surface thereof distalmost from the second transparent layer, and the second transparent layer comprises a plurality of conical frustum depressions at an outer surface thereof distalmost from the first transparent layer.

19. The direct type backlight module as claimed in claim 18, wherein a selected one of the first transparent layer and the second transparent layer of the optical plate is arranged to face the light sources.
